(19) United States
(12) Patent Application Publication
(10) Pub. No.: US 2021/0293042 A1
(43) Pub. Date: Sep. 23, 2021

(54) MODULAR MINI BUILDING SYSTEM FOR PARKING LOTS

(71) Applicant: Jeffrey J. Konczak, Alpena, MI (US)

(72) Inventors: Jeffrey J. Konczak, Alpena, MI (US); Kevin Stevens, Ossineke, MI (US)

(21) Appl. No.: 16/207,370

(22) Filed: Dec. 3, 2018

Related U.S. Application Data
(60) Provisional application No. 62/714,824, filed on Aug. 6, 2018.

(51) Int. Cl. E04H 3/02; G09F 23/00

(52) U.S. Cl. CPC E04H 3/02; G09F 23/00

(57) ABSTRACT

A small modular building system and method for establishing a small scale retail business in an existing parking lot. The building system includes three building modules sized to fit on two trailers, which when assembled form a building with a one-story main service area and an attached tower with a lower story bathroom and an upper story mechanicals/utility room above the bathroom. A further component of the system is a rigid carport arch dimensioned to fit in complementary fashion with one or more of the building modules onto the delivery trailer. A method is also disclosed for delivering, assembling, and installing the modules in an existing parking lot to form a functional, well-anchored building with minimal disruption to the parking lot.

### RELATED APPLICATIONS/PRIORITY BENEFIT CLAIM

This application claims the benefit of U.S. Provisional Application No. 62/714,824 filed Aug. 6, 2018 by the same inventors (Konczak and Stevens), the entirety of which provisional application is hereby incorporated by reference. This application is also related to the co-pending U.S. design patent application Ser. No. 29/659,039 entitled “MODULAR DRIVE-THRU BUILDING” filed Aug. 6, 2018 (attorney docket no. KON-002-D), also by the same inventors (Konczak and Stevens).

### FIELD

The subject matter of the present application is in the field of small modular buildings used for selling retail goods and services.

### BACKGROUND

Small modular buildings for retail food, drive-thru, auto service, and other businesses are known. Examples include those shown in U.S. Pat. No. 5,109,956 to Casale et al. (easily installed food service facility modules for shopping center parking lots); U.S. Pat. No. 5,613,331 to LaGanke (modular oil change and lubrication center for mall parking lots); U.S. Pat. No. 8,622,453 to Karapetian, Jr. (mobile food service unit with drive-thru capability); U.S. Published Application No. 2009/0255195A1 to Bridgman et al. (drive-thru system and method for building in a parking lot); and U.S. Published Application No. 2015/0075271A1 to Tracy et al. (modular, portable, drive-thru tire tread wear and brake testing system for temporary set-up in existing parking lots).

Installing such small retail goods-and-services buildings in existing parking lots, such as those associated with malls and large department stores, places a high premium on efficiency with respect to delivery, assembly or installation, and use. Failure to achieve any of these with respect to a particular building installation can make it impractical.

Another common problem is the regulation and cost associated with putting additional signage in an existing store parking lot. Pylon-type signage limits are often restrictive, and the existing store or mall may not be able to accommodate adequate signage for a complementary business operating out of a modular building installed in the parking lot.

### BRIEF SUMMARY

The present invention is a modular building system, particularly suited for installation of a small modular building in an existing parking lot, for example to house a small retail business complementary to an existing store's business in the store's parking lot. Suitable small retail businesses include, but are not limited to, drive-thru coffee and specialty food establishments smaller than typical full-menu, full-service fast food restaurants.

In a first form, the present system comprises three modular building sections sized to make substantially full use of a standard (non-“wide load”) trailer or tractor-trailer bed for delivery, for example on the order of 9′ (feet) wide by 27′(feet) long. A first building section comprises a main rectangular one-story service area approximating a first trailer bed and configured to be delivered on a first trailer. Second and third building sections comprise dimensionally similar, smaller “cube” sections. The second and third cube sections are configured to be delivered on a second trailer, and to be assembled by stacking them on top of one another to form a multi-story utility tower connected to the main rectangular section when installed in a parking lot.

In a further form, a fourth modular section comprises a carport sized and configured to fit the remaining third of the trailer occupied by the tower cube modules, in complementary relationship to the other modules.

While two tower cubes plus a carport is a preferred combination to substantially fill the space on a trailer bed, it would also be possible to size two tower cubes to substantially fill the trailer bed. If the tower cubes fill the trailer bed, then the carport section may be sized to fit or nest over one of the modular tower cubes (or over the main rectangular building section) in order to stay within the dimensions of the trailer bed.

The modular building sections are fully pre-built prior to being loaded onto the trailers and delivered to the parking lot. By “pre-built” is meant substantially finished and ready for use (kitchen or other retail business appliances, electrical wiring, plumbing, heating and cooling systems, bathrooms, seating, etc.) modules, ready to be connected into a single building and to be hooked up to pre-installed utilites in the parking lot.

The upper tower cube comprises large, flat, elevated side walls suitable for functioning as billboards for business signage at a height above the roof of the main ground level building module. These elevated signage walls comply with sign ordinances due to their height and due to their being an integral part of the building.

In a further aspect of the invention, the modules are anchored to the parking lot using a tie-down system secured in concrete tube forms placed in holes drilled in the parking lot.

In a further aspect of the invention, utilities are provided to the modular building site in the parking lot with directional bore utilities, for minimal disruption to the parking lot surface and subsurface. A “force main” or pressurized type sewer is preferred for similarly minimal disruption to the parking lot.

Particular dimensions and geometry descriptions such as “cube” and “rectangle” are used herein to mean generally or more or less so, and encompass within their scope manufacturing variances, customized or business-specific functional features, variations in trailer widths and lengths, and other factors that will be apparent to those skilled in the art.

These and other features and advantages of the invention will become apparent from the detailed description below, in light of the accompanying drawings.

### BRIEF DESCRIPTION OF THE DRAWINGS

FIG. 1 is a first end perspective view of an exemplary modular building according to the present invention, installed in a parking lot, taken from an elevated vantage point.

FIG. 2 is a perspective view of the pre-built, disassembled module sections of the building of FIG. 1, placed on two tractor-trailers for delivery to the parking lot installation site.

FIG. 3 is an assembly view of the module sections of the building of FIG. 1, exploded relative to their installation positions on concrete tube forms pre-installed in the parking lot.

FIG. 4 is a perspective schematic view of example interiors of the main rectangular building module and the lower story tower cube.

FIG. 5 is a top plan schematic view of the interiors of FIG. 4.

FIG. 6 is a top plan view of the frame structure of the building of FIG. 1, in particular the lower frame and foundation members in contact with, and anchored to, the parking lot.

FIG. 7 is a first end elevation view of the frame structure of the building of FIG. 1, and a section view of the concrete tube forms in the parking lot with anchor tie-downs embedded therein.

FIG. 8 is a first end perspective view of the building of FIG. 1, similar to FIG. 1 but from a parking-lot level vantage point.

FIG. 9 is a first end perspective view of the building of FIG. 1, from an opposing angle.

FIG. 10 is a first end elevation view of the building of FIG. 1.

FIG. 11 is a second end elevation view of the building of FIG. 1.

FIG. 12 is a rear side elevation view of the building of FIG. 1.

FIG. 13 is a front side elevation view of the building of FIG. 1.

FIG. 14 is a top plan view of the building of FIG. 1.

FIG. 15 is an end perspective view, similar to that in FIG. 8, showing the building modified with an additional ground level seating module.

### DETAILED DESCRIPTION

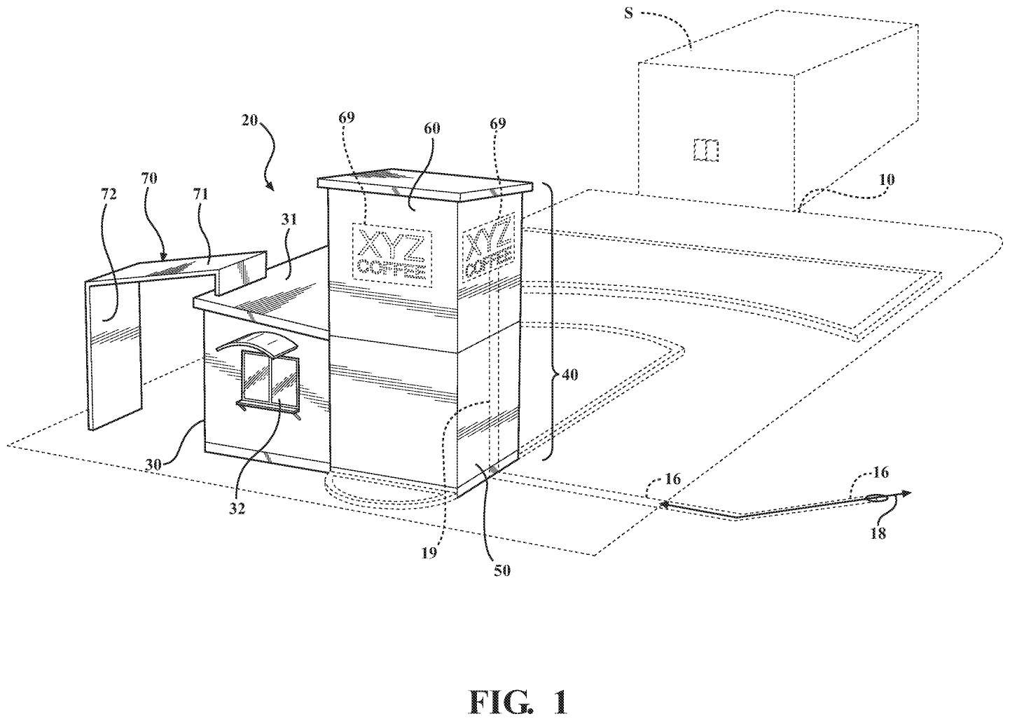

Referring first to FIG. 1, a small modular building 20 is shown installed in a parking lot 10 in order to teach how to make and use the claimed invention. Parking lot 10 in the illustrated example is associated with an existing building or collection of buildings S such as a superstore, shopping center, or retail mall (hereafter “store”). Parking lot 10 need not be associated with a functioning, existing store, however; the parking lot could be an abandoned or empty lot, or a lot associated with a closed or abandoned store.

Modular building 20 is configured for retail sale of goods and/or services, ideally complementary to the business of any existing store S, for example a drive-thru for coffee, donuts, etc. Modular building 20 may also include walk-in or sit-down service for a small number of customers, with limited seating and an ADA-approved restroom. Another possible example of a complementary small business suitable to be conducted from modular building 20 is a pharmacy or other typical in-store department of existing main store S, such that modular building 20 functions as a physically separate department of the main store, with corresponding signage, that can be accessed directly from the parking lot.

Modular building 20 includes a one-story or ground-level main rectangular service module 30, a two-story tower 40 connected to main service module 30 to form a contiguous single building with a common interior, and a drive-thru carport 70.

Main service module 30 houses the equipment and work staff needed to provide the goods or services (e.g., coffee) for drive-thru customers, and optionally includes seating for customers if sit-down service is offered. Equipment will depend on the type of business, but things such as stoves and ovens, refrigerators and freezers, counters, sinks, dishwashers, computers, cash registers/terminals, coffee-brewing machines, drive-thru order taking systems, lighting, and display boards and cabinets would be typical for a food-related business.

Tower 40 includes upper and lower modular cube sections 50, 60 each of which comprise a room. Upper section 60 is the “mechanical” room, housing the primary in-house electrical and plumbing apparatus such as HVAC equipment, junction boxes and breaker panels, and water tanks and treatment. Lower section 50 is a restroom, meeting ADA standards, with a door 33′ connecting it with the interior of main service module 30 for the use of workers and customers. Lower section 50 may also include a janitorial storage area for cleaning supplies.

Utilities 18 such as water, electrical power, gas, sewer, and/or communications are provided to the modular building 20 via one or more directional bores schematically shown at 16 in FIG. 1. Directional bore 16 preferably opens in an unpaved area outside the parking lot 10 in known manner, and is drilled laterally underneath the parking lot surface to a location under the modular building's installation site using known techniques. The in-house utility systems in the modular building may be connected to the water, power, gas, and communication-using apparatus in building 20 with known types of connections located in the base of the lower tower module 50 and extending or branching to the upper tower module 60, the connections schematically shown at 19 in FIG. 1.

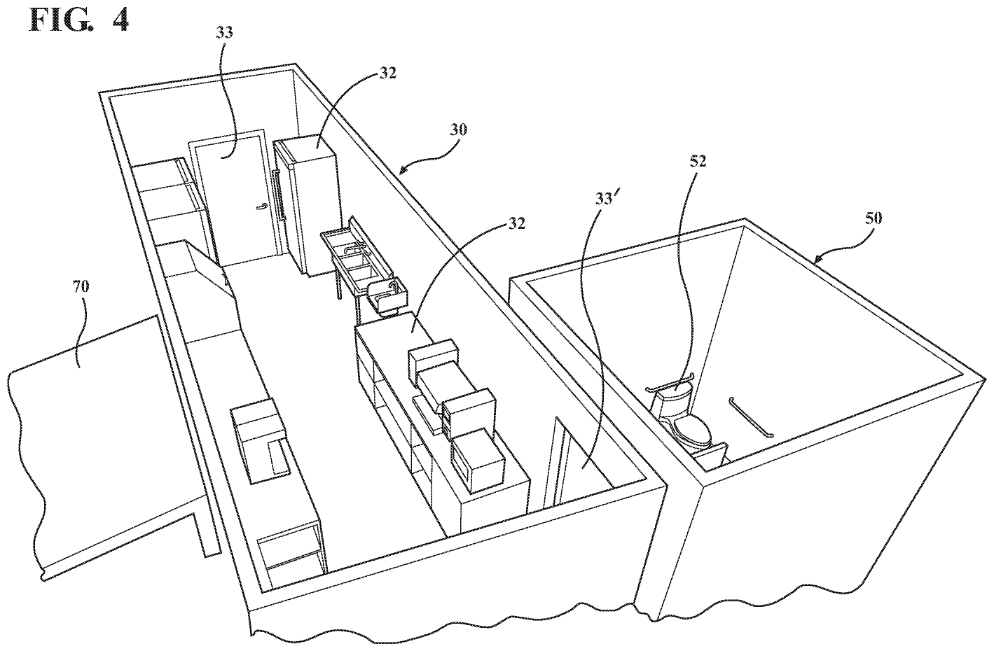

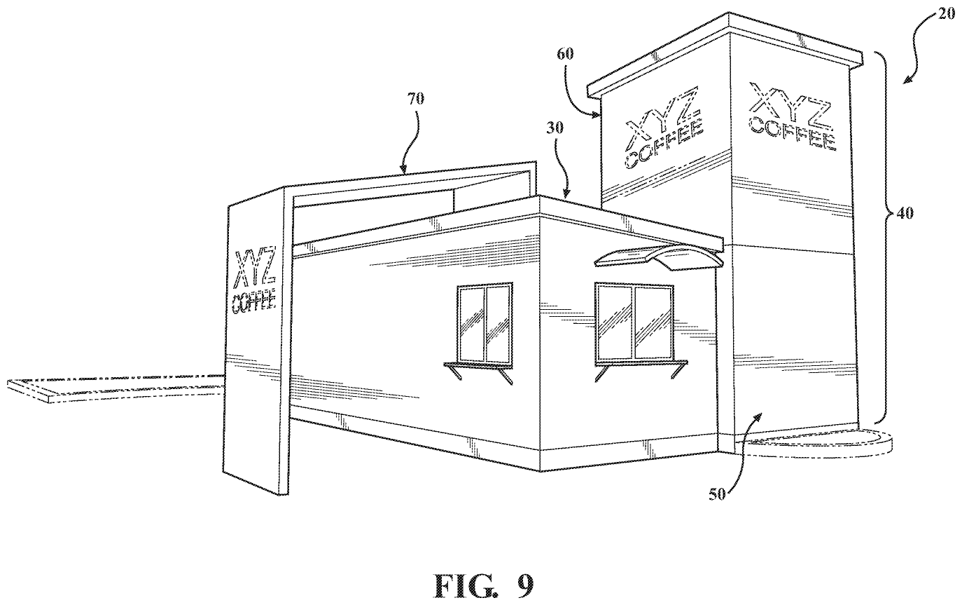

Modular building 20 includes a rigid drive-thru carport 70 comprising a sidewall 72 and a roof 71 connected to the main service module 30, for example at the roof 31. Drive-thru service features such as cashier and food delivery windows 32 are provided in the main service module 30, at least one of which (FIGS. 4, 5, and 9) is associated with the area covered by carport 70. A door 33 (FIGS. 4, 5, and 11) is provided in at least one of the walls of service module 30 for entry and exit by workers and customers.

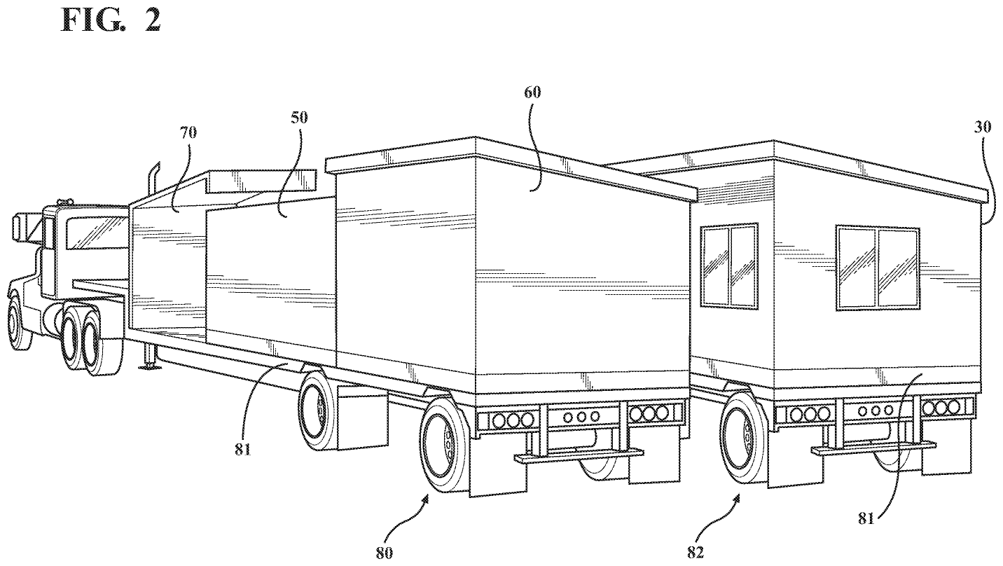

FIG. 2 shows the constituent modules 30, 50, and 60 that form the modular building 20, loaded onto two tractor-trailers 80, 82 of known type for delivery to the parking lot. Main service module 30 is sized to fit on and make substantially full use of one tractor-trailer bed 81 for delivery to the parking lot installation site in a single story configuration. Tower cube modules 50 and 60 and carport 70 are sized to fit on and substantially fill another substantially identical tractor-trailer bed 81 for delivery to the parking lot installation site in a single story disassembled configuration. In the illustrated example, main service module is approximately 9′ (feet) wide by 27′ (feet) long, making full use of a 9′×27′ standard tractor-trailer bed. Illustrated tower cube modules 50 and 60 are dimensionally similar with 9′×9′ footprints and similar (although not necessarily identical) wall heights. Carport 70 may have a sidewall height approximating the height and/or width dimensions of the tower cube and main service modules as illustrated in FIG. 2, for example 9′ (feet), in order to fit neatly into the remaining space on the second tractor-trailer bed 81 with the tower cube modules. The length of the carport roof portion may be longer, and the carport can be positioned so that at least some of the roof overlaps an adjacent module on the trailer.

Likewise, if a third tower cube (not shown, but substantially the same as either one of modules 50, 60) is desired for a taller assembled tower, or if modules 50 and 60 are sized differently to take up the entirety of the trailer bed on their own, the example illustrated carport sidewall and roof dimensions can be sized to fit or nest against one of the sidewalls and over an upper edge or roof portion of the adjacent tower cube module for delivery on the same trailer.

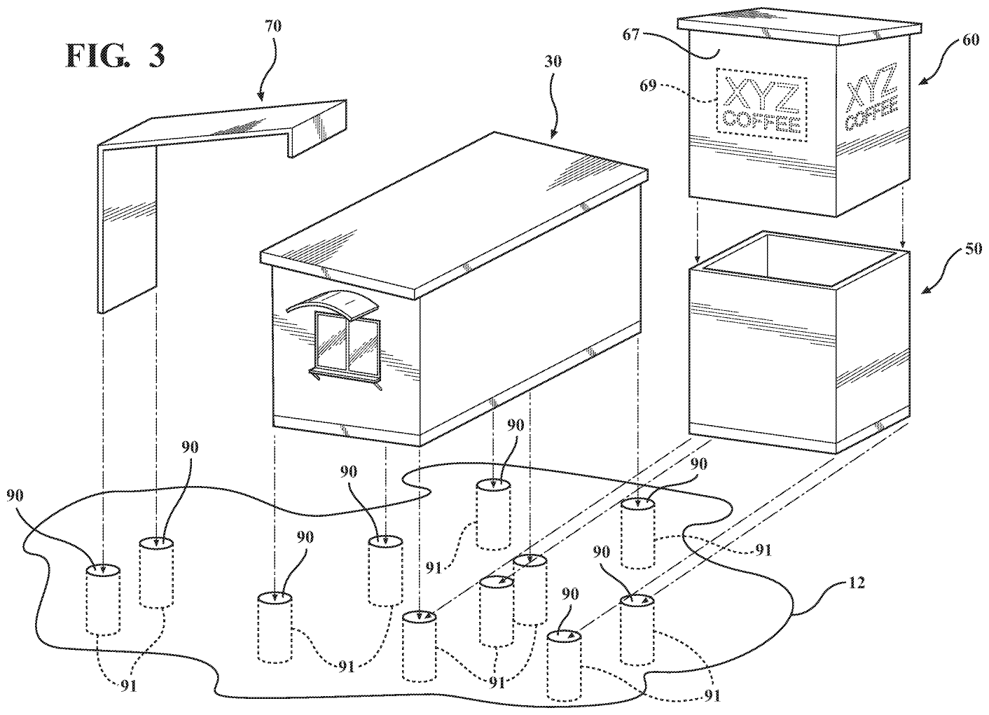

FIG. 3 shows the constituent modules of building 20 in an exploded assembly relationship relative to the designated installation site 12 on parking lot 10. Installation site 12 is provided with anchor points 90 prior to delivery and assembly of the modules. In the illustrated example, anchor points 90 are commercially available concrete tube forms placed in bores 91 drilled into the pre-existing parking lot surface and subsurface, in a pattern corresponding to the lower frame outlines of the first-story building modules in their joined-together configuration. Modules 30, 50, 60, and 70 are pre-built and can simply be lowered or skidded into position to be joined together over the bores 91 and their empty concrete tube forms 90, with anchors or ties extending from the lower module frames into the tubes to be secured with a subsequent filling of concrete or equivalent anchoring material poured into the tubes.

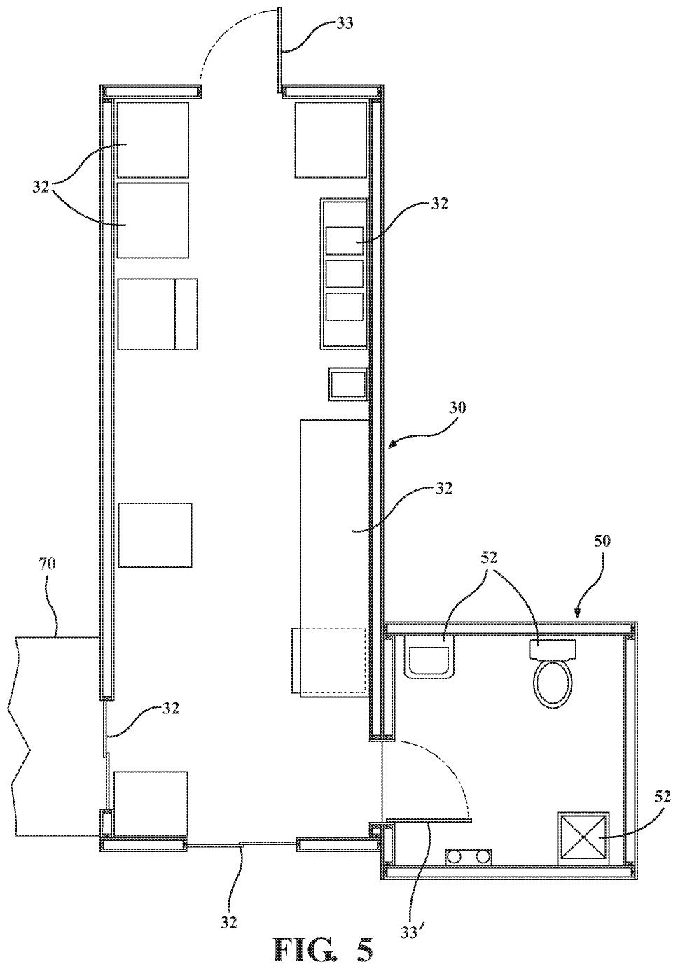

FIGS. 4 and 5 are schematic representations of example interiors of the main service module 30 and the lower tower cube module 50. The relevant interior features and equipment 32, 52 that make the joined modules functional as a retail business are pre-installed in their respective modules prior to delivery to installation site 12. The same is true of the mechanical and utility-room features of the upper tower cube module 60. The modules 30, 50, and 60 are accordingly pre-built prior to delivery to the installation site on a parking lot, so that connecting them to one another and to the on-site utility supply lines (water, sewer, electric, communication) makes the modular building 20 functional. It should be understood that minor finishing and customizing touches may be reserved, if desired, for installation or application after the basic pre-built functional modules are delivered and assembled on-site, such as painting, trim, floor finishes, etc.

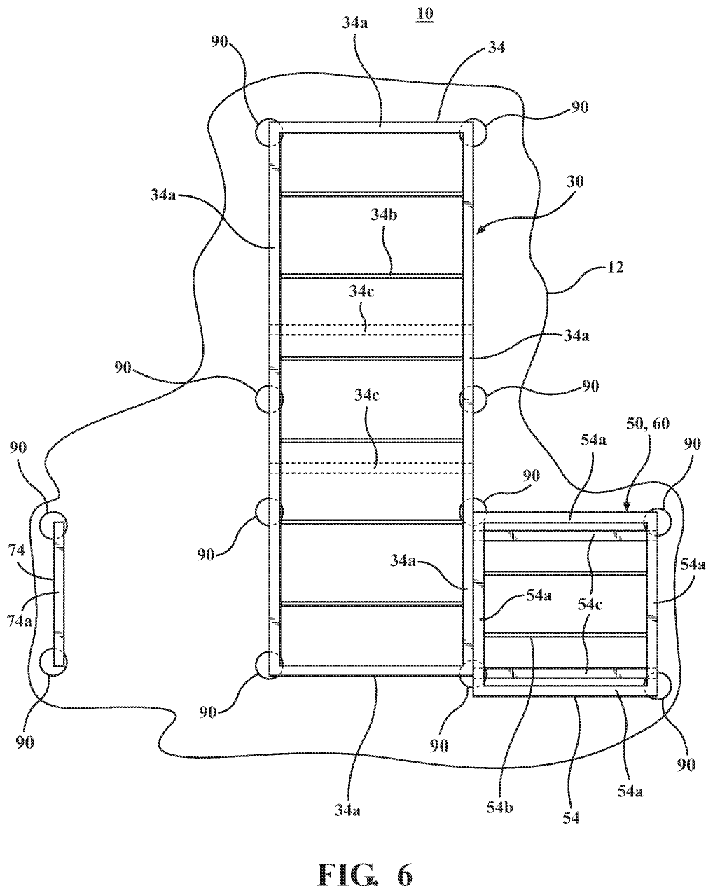

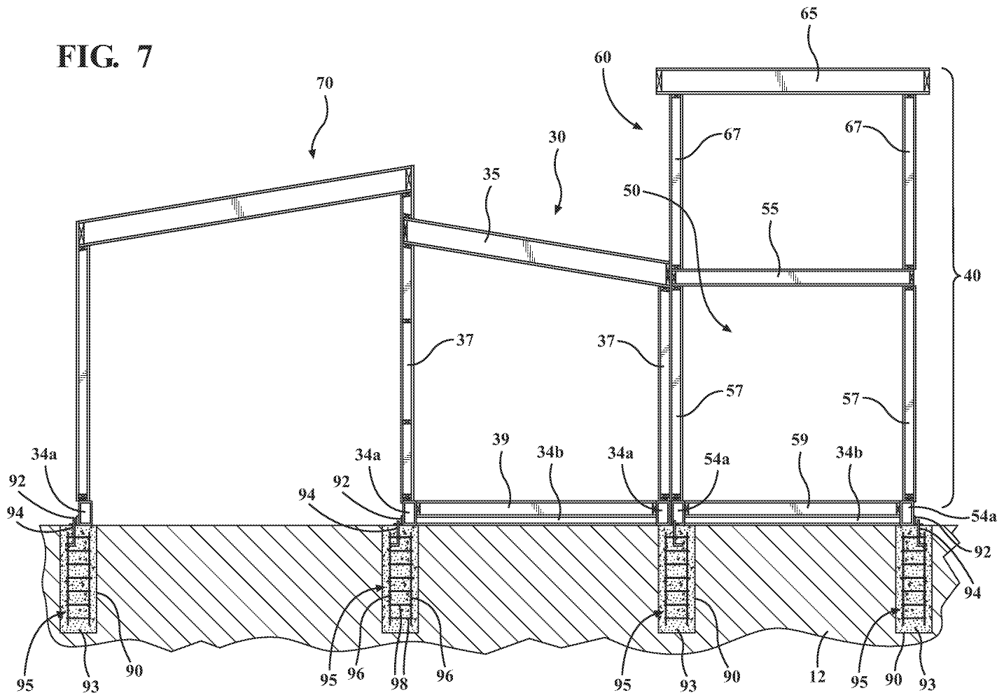

FIGS. 6 and 7 show the preferred frame-and-panel construction of the modules 30, 50 and 60. In FIG. 6, the lower edges 34, 54, 74 of the respective ground-level modules (main, restroom, and carport) are formed by rectangular steel tubing to form a steel skid foundation. The concrete tube forms 90 are installed to be aligned with the outermost lower frame members 34a, 54a, 74a in a desired anchor pattern. Cross-members 34b, 54b serve as internal frame bracing and/or floor panel supports. The steel frame members may be joined using known types of mechanical fasteners or welding techniques. FIG. 6 also shows forklift channels 34c and 54c associated with the lower frame members of each module, useful for moving the modules on and off delivery trucks and for positioning or lifting the modules at the building site. The steel frame members may be supplemented in known manner, for example with treated lumber overlaid on the frame to help bear the weight of wall panels.

FIG. 7 additionally shows structural insulated panels of known type used for the walls and roof portions of the various modules, joined directly together in known fashion. Main service module 30 has roof panels 35, wall panels 37, and floor panels 39. Lower tower cube module 50 has ceiling, wall, and floor panels 55, 57, and 59. Upper tower cube module has roof and wall panels 65, 67, with the ceiling panel 55 of the lower tower cube module functioning as the floor of the upper room. While the example frame and panel construction is preferred for the modules, other known types of construction and/or materials may be suitable and used depending on factors such as preference, climate, and local building codes. The exterior surfaces of the modules may be faced with various materials suitable for the local aesthetic preferences or requirements, weather conditions, or other factors.

The lower steel frame/foundation members 34a, 54a, 74a of the modular building 20 are secured in the pre-installed concrete tube forms 90 via angle iron members 92 connected at one end to the steel frame/foundation members and at their other end to hook anchors 94. The lower ends of hook anchors 94 extend down into the interiors of concrete tube forms 90, where they are connected to reinforced steel anchor structures 95 located in the concrete tube forms. In the illustrated example, anchor structures 95 are formed from a vertical rectangular array of spaced rebar 96 connected with a spaced array of horizontal steel hoops 98 to form a lattice-like column. Once the anchors 94 and anchor structures 95 are positioned in concrete tube forms 90, concrete 93 can be poured into the tube forms, flowing around the anchors to harden and secure the modular building in place.

It will be understood that other known anchoring structures and techniques suitable may be suitable for securing modular building 20 to an existing parking lot, but the structure and method disclosed above is preferred and believed to be superior to other tie-down type foundations. The manner of assembling or connecting the pre-finished modules 30, 40, 50, and 70 to one another will be apparent to those skilled in the art, and may comprise any known technique or combination of techniques, such as but not limited to the use of self-tapping metal screws, coarse-threaded bolts through pre-formed bores in frame members, nailing, structural adhesives, and combinations thereof.

FIGS. 1-7 also generally show the upper walls 67 of tower portion 40, i.e. the sidewalls of the upper tower cube module 60, being used as the “billboard” or sign for the retail business operated out of modular building 20. The height of the walls of the upper cube module 60 provide suitable square footage and a height above the roof portion of main service module 30 to allow the name of the business to be clearly displayed on a designated signage portion 69, optionally on all sides to potential customers in the parking lot. This sign-supporting capability of the upper walls of the tower portion of the modular building eliminates the need for costly (and sometimes restricted) pylon signage, because the sign surfaces are part of the building itself.

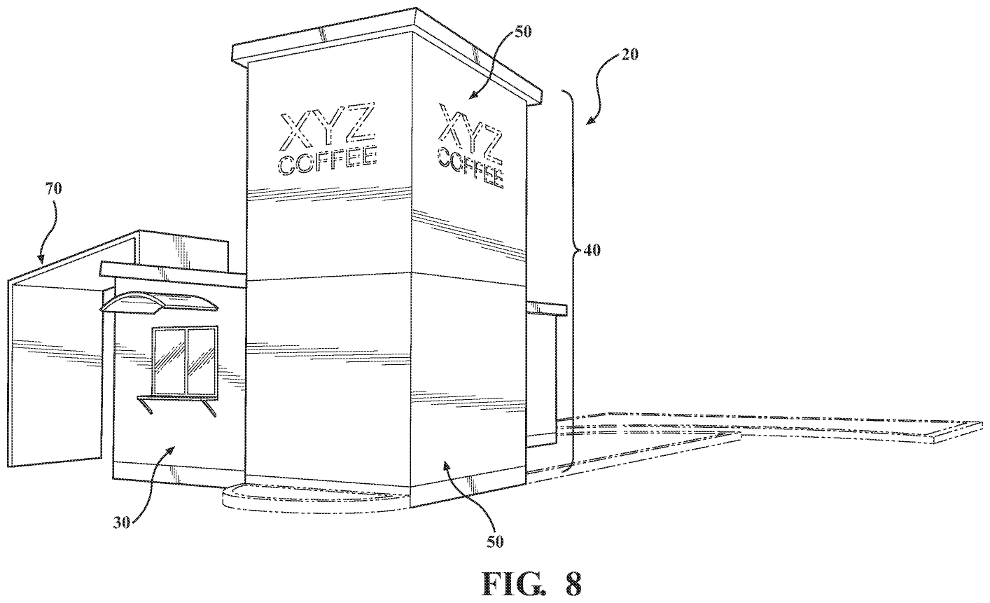

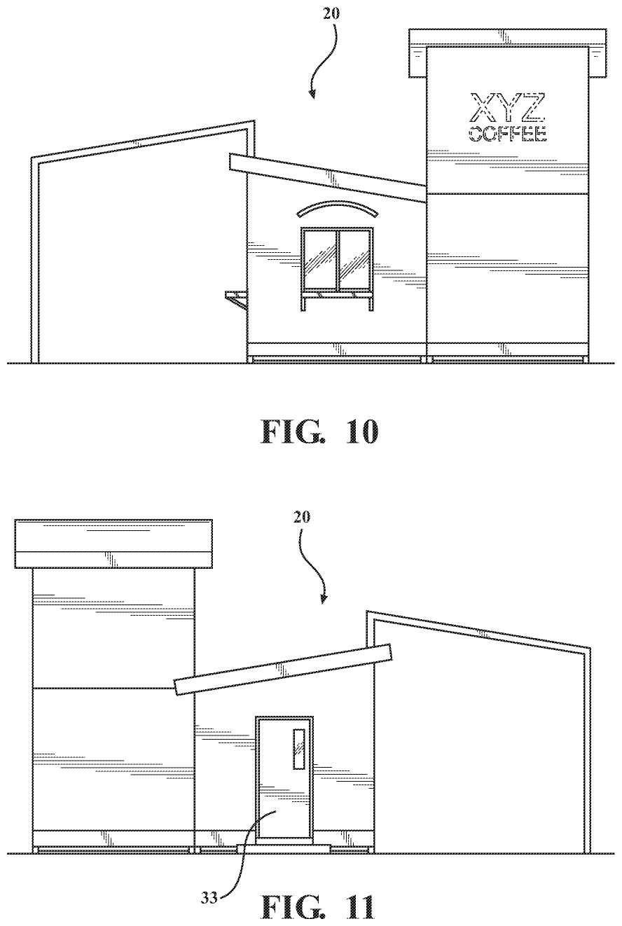

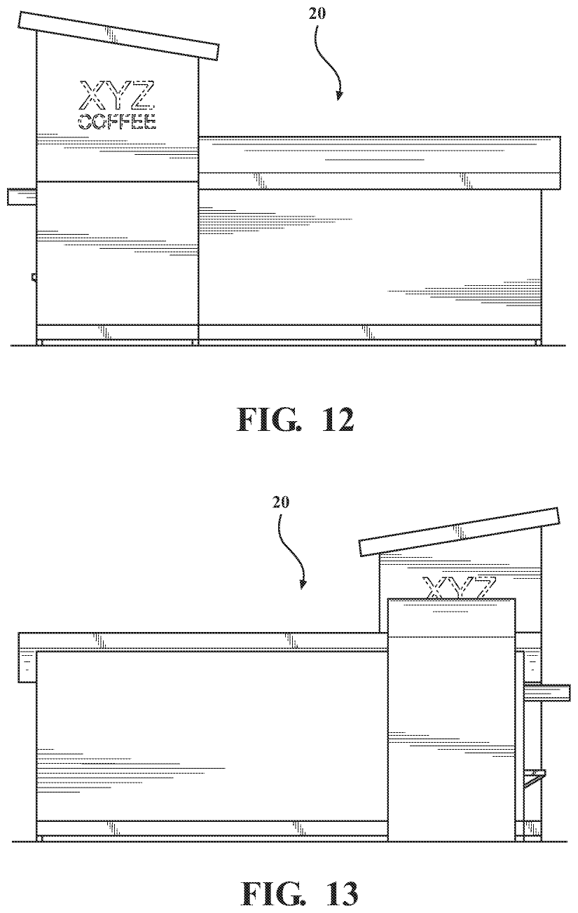

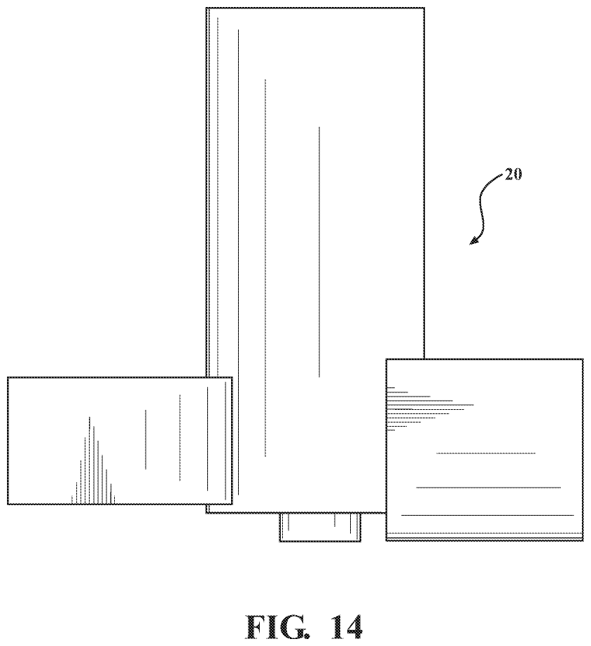

FIGS. 8-14 illustrate the external appearance of the example assembled building of FIGS. 1-7 from different perspectives. The proportions and relative dimensions of the illustrated modules, their roof configurations, door and window configurations, the location and shape of the carport, and the relative positions of the modules to one another when assembled into a building may vary from those shown according to aesthetic preference, available delivery trailer dimensions for the various modules, number of modules assembled, and other factors that will now be apparent to those skilled in the art. Exterior surface finishes may of course vary depending on aesthetic preference and the illustrated modules are not limited to any particular surface finish or material.

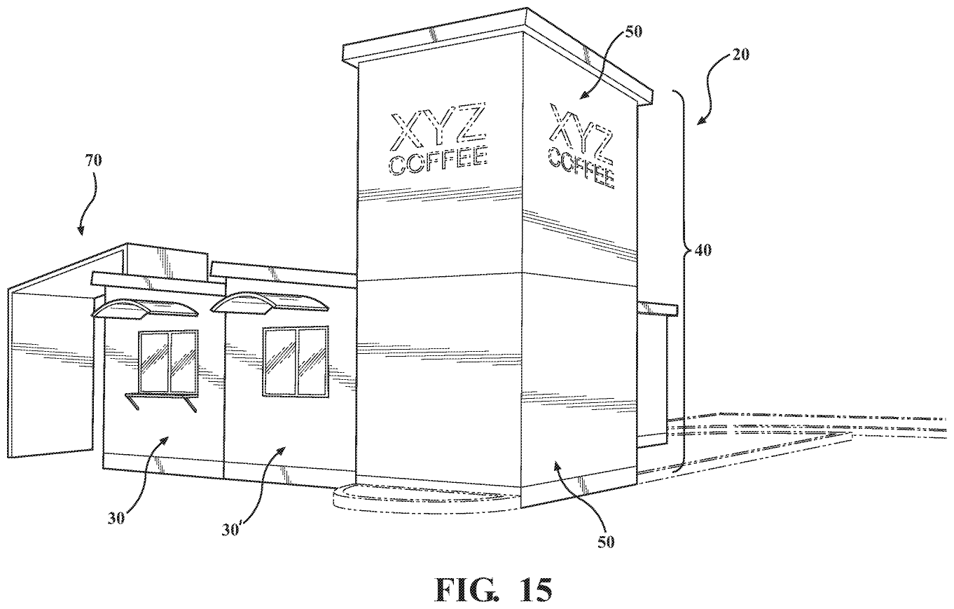

The modular nature of the main service module 30 and the tower cube modules 40, 50, their simple manner of assembly to one another and placement and anchoring on a parking lot building site, and the centralized utility function of the upper tower module allow different combinations of modules to be assembled as needed or desired with differing relative positioning to one another. For example, as shown in FIG. 15, an extra ground-level service module 30′ can be added between the main service module 30 and the tower modules 40, 50 so that the outer service module 30 can be dedicated for customer seating, while the inner service module 30′ functions as the main kitchen and service area, with pass-through interior doors between the main service modules 30, 30′ and the lower bathroom module 40 on the assembled tower. Another example would be positioning the tower assembly 40, 50 along a middle portion of the sidewall of main service module 30 rather than at one end of the main service module sidewall.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A small modular building system configured for installation in an existing parking lot to form a modular building configured to house a small retail business, the modular building system comprising:
a first main service section comprising a rectangular one-story service area module having a first width and a first length significantly greater than the first width;
second and third tower sections each comprising a dimensionally similar one-story cube having a second length approximating the first width and a second width approximating the first width, the second and third tower sections configured to be stacked on top of one another and attached to the first main section to comprise a multi-story tower contiguous with the first main section and having a height greater than a height of the first main section.

2. The modular building system of claim 1, wherein the first main service section and the second and third tower sections are sized to fit on and make substantially full use of a pair of standard sized tractor-trailer beds for delivery in a single story disassembled configuration, each of the pair of tractor-trailer beds having a third width corresponding to the first width and a third length corresponding to the first length.

3. The modular building system of claim 2, further including a modular carport section comprising a roof and a side wall, the modular carport section having a wall height approximating a height and/or width of the main service section and having a roof length equal to or greater than the first width, the modular carport section further being configured to be connected to the main service section to provide a covered drive-thru area adjacent a sidewall of the main service section.

4. The modular building system of claim 1, wherein the second tower section comprises a ground-story restroom module and the third tower section comprises an elevated utility module above the restroom module and elevated relative to the main service area module.

5. The modular building system of claim 1, wherein the modular building is secured to the parking lot with anchor structures anchored in concrete tube forms formed in bores drilled vertically in the parking lot.

6. The modular building system of claim 1, wherein the third tower section comprises four walls comprising large flat surfaces elevated above a roof portion of the first main section, and further wherein a sign corresponding to the business is located on one or more of the four walls.

7. The modular building system of claim 1, wherein a modular building formed from the first main section and the second and third tower sections is installed on a pre-existing parking lot and configured to operate the small retail business.

8. The modular building system of claim 7, wherein the pre-existing parking lot is shared by a main retail business, and further wherein the small retail business is complementary to the main retail business.

9. A method of providing a modular building for conducting a retail business in a parking lot, comprising:
pre-fabricating offsite a first main service section comprising a rectangular one-story service area module having a first width and a first length that is greater than the first width;
pre-fabricating offsite second and third tower sections each comprising a one-story cube having a second length that is the same or approximately the same as the first width and a second width that is the same or approximately the same as the first width, the second and third tower sections configured to be stacked on top of one another and attached to the first main section to comprise a multi-story tower contiguous with the first main service section and having a height greater than a height of the first main section;
the first main service section and the second and third tower sections being sized to fit on a pair of tractor-trailer beds for delivery in a single-story disassembled configuration to the parking lot, each of the pair of tractor trailer beds having a third width corresponding to the first width and a third length corresponding to the first length;
loading the pre-fabricated first main service section on a first one of the pair of tractor trailer beds;
loading the pre-fabricated second and third tower sections on a second one of the pair of tractor trailer beds;
delivering the pre-fabricated first main service section and the pre-fabricated second and third tower sections to the parking lot and assembling them into a modular building comprising a ground level first main service section and a multi-story tower section comprising the second and third tower sections stacked upon each other and having a height greater than a height of the first main service section, wherein the second tower section is contiguous with the ground level first main service section, and the third tower section is stacked upon the second tower section.

10. The method of claim 9, further comprising anchoring foundation portions of the modular building to the parking lot with anchor structures secured in concrete tube forms placed in holes drilled in the parking lot.

11. The method of claim 9, further comprising providing utilities to the modular building in the parking lot with directional bore utilities extending from a location outside the parking lot to the modular building.

12. The method of claim 9, further comprising:
pre-fabricating offsite a modular carport section comprising a roof and a side wall, the modular carport section having a wall height the same or approximately the same as a height and/or width of the main service section and having a roof length equal to or greater than the first width, the modular carport section further being configured to be connected to the main service section to provide a covered drive-thru area adiacent a sidewall of the main service section; and
delivering the modular carport section to the parking lot and connecting it to the main service section as part of the assembled modular building.

13. The method of claim 9, wherein the second tower section comprises a restroom module and the third tower section comprises an utility module.

14. The method of claim 9, wherein the third tower section comprises four walls comprising flat surfaces and business signage located on one or more of the four walls, and wherein, in the assembled modular building, the business signage is elevated above a roof portion of the first main section.

15. The method of claim 9, wherein the parking lot is shared by a retail business.
